(19) United States
(12) Patent Application Publication
(10) Pub. No.: US 2026/0291690 A1
(43) Pub. Date: Sep. 24, 2026

(54) METHOD AND APPARATUS FOR UPLINK CONTROL INFORMATION TRANSMISSION IN MOBILE COMMUNICATIONS

(71) Applicant: MediaTek Singapore Pte. Ltd., Singapore (SG)

(72) Inventors: Jozsef Gabor NEMETH, Cambridge (GB); Mohammed S Aleabe AL-IMARI, Cambridge (GB); Pradeep JOSE, Cambridge (GB); Sylvio Paul Mathieu BARDES, Cambridge (GB)

(73) Assignee: MediaTek Singapore Pte. Ltd., Singapore (SG)

(21) Appl. No.: 19/475,697

(22) PCT Filed: Oct. 11, 2024
(86) PCT No.: PCT/CN2024/124109

§ 371 Date: Oct. 15, 2025

Related U.S. Application Data
(60) Provisional application No. 63/589,344, filed on Oct. 11, 2023.

(51) Int. Cl. H04L 5/00; H04B 7/06; H04W 72/21; H04W 72/231; H04W 72/232

(52) U.S. Cl. CPC H04L 5/0055; H04B 7/0626; H04W 72/21; H04W 72/231; H04W 72/232

(57) ABSTRACT

Various solutions for uplink control information (UCI) transmission with respect to an apparatus in mobile communications are described. The apparatus may receive a downlink information. The apparatus may determine a media access control-control element (MAC-CE) according to the downlink information. The MAC-CE may include at least one of a hybrid automatic repeat request-acknowledgment (HARQ-ACK) codebook and a channel state information (CSI) report. The apparatus may transmit a MAC packet data unit (MAC PDU) including the MAC-CE.

### CROSS REFERENCE TO RELATED PATENT APPLICATION(S)

The present disclosure is part of a non-provisional application claiming the priority benefit of U.S. Patent Application No. 63/589,344, filed 11 Oct. 2023, the content of which herein being incorporated by reference in its entirety.

### TECHNICAL FIELD

The present disclosure is generally related to mobile communications and, more particularly, to uplink control information (UCI) transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, downlink control information (DCI) may include scheduling information for user equipment (UE) to receive or transmit data via scheduled network resources. More specially, based on a downlink (DL) DCI, the UE may receive a physical downlink shared channel (PDSCH) from the network node after k0 slot(s) which is (are) configured between the DL DCI and the PDSCH, and transmit a physical uplink control channel (PUCCH) (e.g., a PUCCH including HARQ-ACK) to the network node after k1 slot(s) which is (are) configured between the PDSCH and the PUCCH. Furthermore, based on an uplink (UL) DCI, the UE may transmit physical uplink shared channel (PUSCH) to the network node after k2 slot(s) which is (are) configured between the UL DCI and the PUSCH. In addition, from decoding the DL DCI to being ready to receive the PDSCH, N1 symbols represent the required time. From receiving an UL DCI to preparing the PUSCH transmission, N2 symbols represent the required time, which is used to ensure that the UE may have sufficient time to prepare the PUSCH transmission.

In some network scenarios, transmission overrides and transmission arbitrations may occur, and then be affected by various network conditions. For example, in some network scenarios on the same component carrier (CC) or across CCs, after receiving a DCI, the UE determines corresponding PDSCH and PUCCH including HARQ-ACK. Subsequently, the UE receives another DCI and determines corresponding PDSCH and PUCCH including HARQ-ACK, which causes HARQ uplink control information (UCI) reselection. The HARQ UCI delays all possible transmission arbitrations until N1 symbols before the last PUCCH. For another example, in some network scenarios across CCs, after receiving a DCI, the UE determines corresponding PUSCH including HARQ-ACK of PUCCH. Subsequently, the UE receives another DCI and determines corresponding PUSCH including HARQ-ACK of PUCCH. When the PUSCHs are determined overlapped with respect to time domain, PUSCH rate rematching is delayed until some transmission arbitrations (e.g., arbitrations between PUSCHs) are completed. Further, in some network scenarios, a configured grant may be overridden by a dynamic grant (e.g., grant for PUSCH) any time before timeline of N2 symbols starts. However, these transmission overrides, transmission arbitrations and potential delays, especially layer 1 related, may cause increases of computational complexity and overall network delays.

Accordingly, how to avoid transmission overrides, transmission arbitrations and potential delays becomes an important issue in the newly developed wireless communication network. Therefore, there is a need to provide proper schemes to avoid transmission overrides, transmission arbitrations and potential delays.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to uplink control information transmission with respect to apparatus in mobile communications.

In one aspect, a method may involve an apparatus receiving, a downlink information. The method may further involve the apparatus determining a media access control-control element (MAC-CE) according to the downlink information. The MAC-CE may include at least one of a HARQ-ACK codebook and a channel state information (CSI) report. The method may further involve the apparatus transmitting a MAC packet data unit (MAC PDU) including the MAC-CE.

In one aspect, a method may involve an apparatus transmitting a downlink information for determining a MAC-CE according to the downlink information. The MAC-CE may include at least one of a HARQ-ACK codebook and a CSI report. The method may further involve the apparatus receiving a MAC PDU including the MAC-CE.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, by the transceiver, a downlink information. The processor may further perform operations comprising determining a MAC-CE according to the downlink information. The MAC-CE may include at least one of a HARQ-ACK codebook and a CSI report. The processor may further perform operations comprising transmitting a MAC PDU including the MAC-CE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a diagram depicting an example scenario under schemes in accordance with implementations of the present disclosure.

FIG. 11 is a diagram depicting an example scenario under schemes in accordance with implementations of the present disclosure.

FIG. 12 is a block diagram of an example communication system in accordance with an implementation of the present disclosure.

FIG. 13 is a flowchart of an example process in accordance with an implementation of the present disclosure.

FIG. 14 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink control information (UCI) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a downlink information (e.g., channel state information-reference signal (CSI-RS), downlink control information (DCI) etc.) to a user equipment (UE). Based on receiving the downlink information, the UE may determine a media access control-control element (MAC-CE) according to the downlink information. The MAC-CE may include at least one of a hybrid automatic repeat request-acknowledgment (HARQ-ACK) codebook and a channel state information (CSI) report. The UE may transmit a MAC packet data unit (MAC PDU) including the MAC-CE to the network node. In other words, the UE may transmit the HARQ-ACK codebook and/or the CSI as the MAC-CE to the network node. Therefore, because the UCI such as the HARQ-ACK codebook and/or the CSI report may be transmitted as layer 2 MAC-CE, some layer 1 transmission arbitrations and transmission overrides (e.g., transmission arbitrations between HARQ-ACK related PUCCH and HARQ-ACK related PUCCH, or transmission overrides related to PUSCH overlapping with HARQ-ACK related PUCCH, etc.) may be avoided or ignored so that the related delays may not occur.

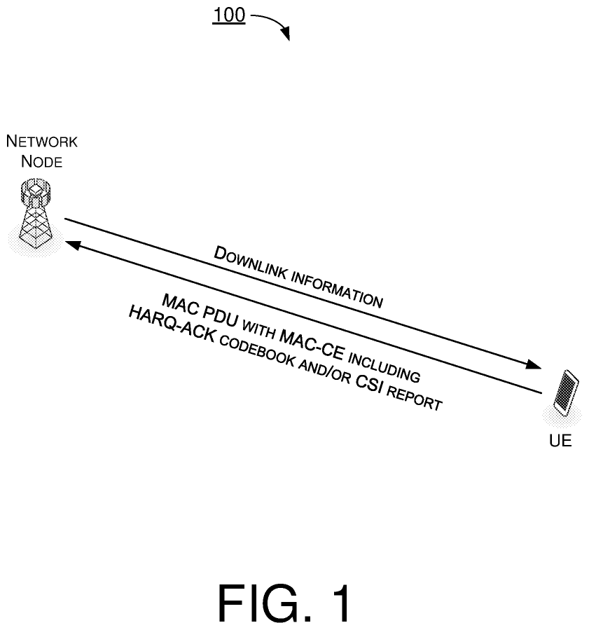

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a downlink information (e.g., CSI-RS, DCI etc.) to the UE. After receiving the downlink information, the UE may determine a HARQ-ACK codebook related to the downlink information (i.e., DCI) or a CSI report related to the downlink information (i.e., CSI-RS). The UE may determine a MAC-CE which includes the HARQ-ACK codebook and/or the CSI report. The UE may multiplex the MAC-CE with a MAC service data unit (SDU) to form a MAC PDU. The UE may transmit the MAC PDU including the MAC-CE to the network node. In other words, the UE may transmit the HARQ-ACK codebook and/or the CSI as the MAC-CE to the network node. The network node may receive the MAC PDU including the MAC-CE.

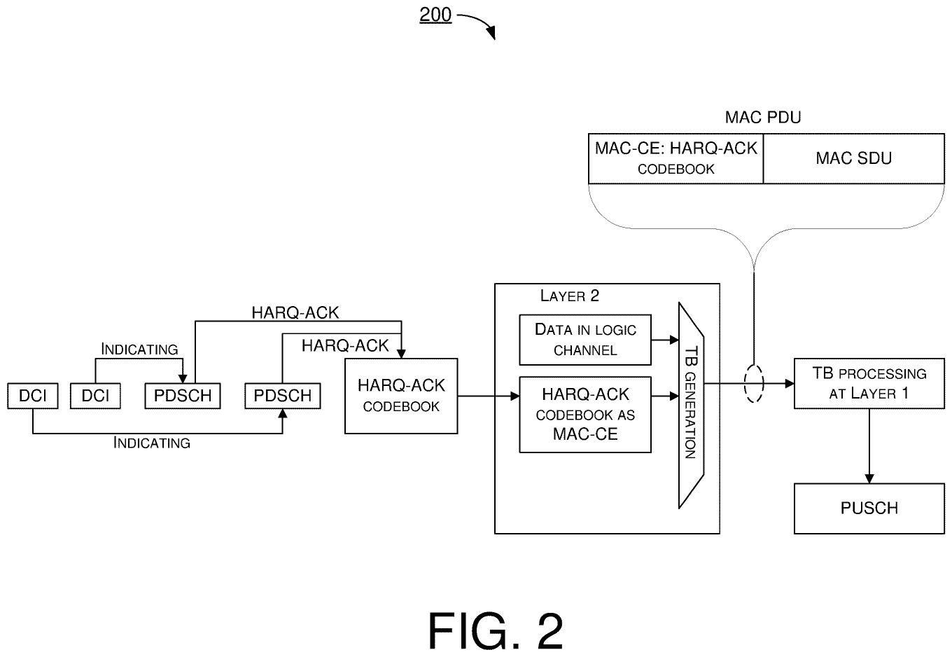

FIG. 2 illustrates an example scenario 200 under schemes in accordance with implementations of the present disclosure. In some embodiments, the network node may transmit one or more DCIs to the UE. After receiving the one or more DCIs, the UE may determine one or more physical downlink shared channels (PDSCHs) based on the DCIs and determine a HARQ-ACK codebook based on HARQ-ACK(s) corresponding to the one or more PDSCHs. Then, at layer 2, the UE may encode the HARQ-ACK codebook as a MAC-CE and multiplex the MAC-CE with a MAC service data unit (MAC SDU) (i.e., data in logic channel) to form a MAC PDU. The UE may generate a transport block (TB) at layer 2 for transmitting the MAC PDU and process the TB at layer 1 for later physical uplink shared channel (PUSCH) transmission.

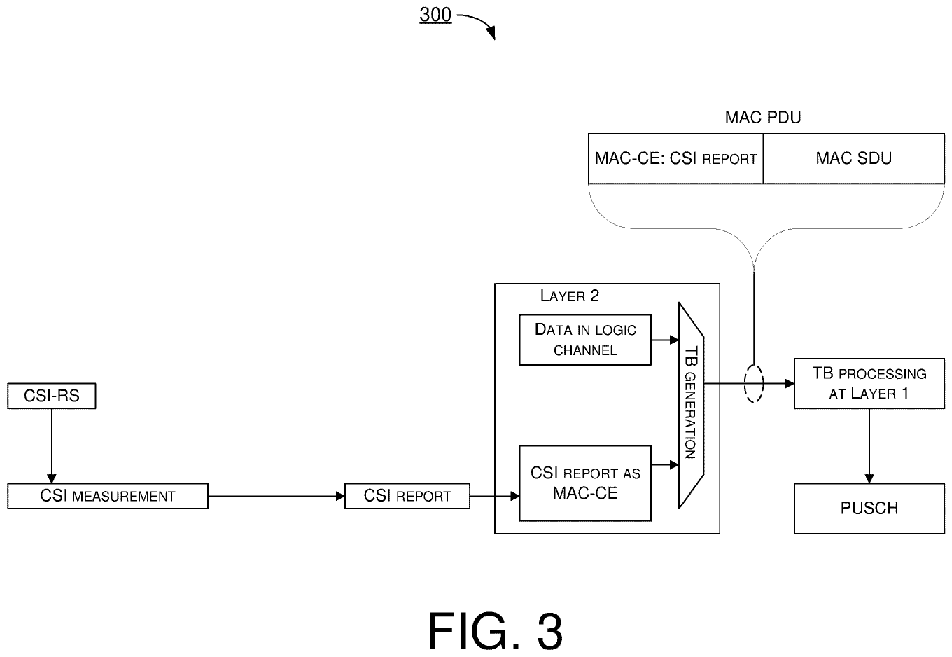

FIG. 3 illustrates an example scenario 300 under schemes in accordance with implementations of the present disclosure. In some embodiments, the network node may transmit one or more CSI-RSs to the UE. After receiving (i.e., detecting) the one or more CSI-RSs, the UE may determine one or more CSI measurements based on the CSI-RS and determine one or more CSI reports based on the one or more CSI measurements. Then, at layer 2, the UE may encode the one or more CSI reports as a MAC-CE and multiplex the MAC-CE with a MAC SDU (i.e., data in logic channel) to form a MAC PDU. The UE may generate a TB at layer 2 for transmitting the MAC PDU and process the TB at layer 1 for later PUSCH transmission.

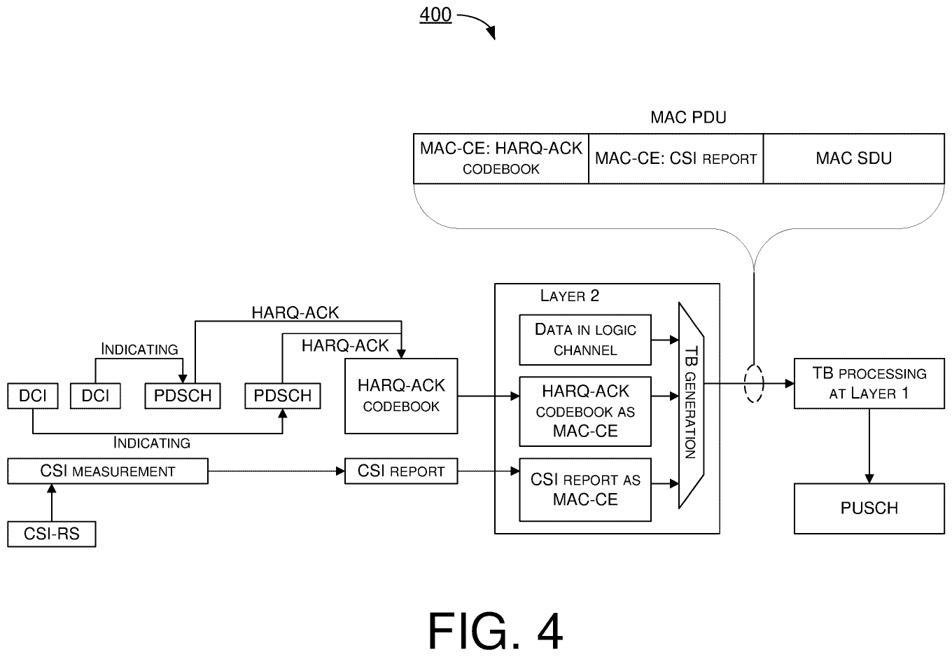

FIG. 4 illustrates an example scenario 400 under schemes in accordance with implementations of the present disclosure. In some embodiments, the network node may transmit: (1) one or more DCIs; and (2) one or more CSI-RSs to the UE. After receiving the one or more DCIs, the UE may determine one or PDSCHs based on the DCIs and determine a HARQ-ACK codebook based on the one or more PDSCHs. After receiving the one or more CSI-RSs, the UE may determine one or more CSI measurements based on the CSI-RS and determine one or more CSI reports based on the one or more CSI measurements. Then, at layer 2, the UE may encode the HARQ-ACK codebook and the one or more CSI reports as MAC-CEs, and multiplex the MAC-CEs with a MAC SDU (i.e., data in logic channel) to form a MAC PDU. The UE may generate a TB at layer 2 for transmitting the MAC PDU and process the TB at layer 1 for later PUSCH transmission.

It should be noted that, in the above embodiments, it is not intended to limit the contents of the MAC PDU. The MAC PDU may include MAC-CE including buffer status report (BSR), padding, etc. when necessary.

In some implementations, the MAC-CE header of the MAC PDU may be without length field. In particular, based on a legacy MAC-CE header, there may be a length field indicating size of MAC-CE payload. Based on the MAC-CE header of the MAC PDU of the present disclosure, because the MAC-CE may include at least of one of the HARQ-ACK codebook and the CSI report which are denoted by the network node, the size of the MAC-CE may not need to be reported to the network node. In other words, the MAC-CE header of the MAC PDU of the present disclosure may not include length field as the length of the MAC-CE including at least of one of the HARQ-ACK codebook and the CSI report may be known to the network node.

In some implementations, an index of the HARQ-ACK may be included in a MAC-CE header or a payload of the MAC PDU. In particular, rather than indicating the index of the HARQ-ACK codebook by slot of the HARQ-ACK codebook transmission based on the legacy method, the index of the HARQ-ACK codebook may be indicated to the network node by including the index in: (1) the MAC-CE header; or (2) the payload of the MAC PDU.

In some implementations, when the downlink information includes the DCI (e.g., DL DCI indicating resources for DL transmission,) the DCI may include a codebook index indicating an index of the HARQ-ACK codebook (e.g., one index for Type 1 HARQ-ACK codebook and the other index for Type 2 HARQ-ACK codebook). More specially, based on a DL DCI, the UE may receive a PDSCH from the network node after k0 slot(s) which is (are) configured between the DL DCI and the PDSCH, and transmit a physical uplink control channel (PUCCH) (e.g., a PUCCH including HARQ-ACK) to the network node after k1 slot(s) which is (are) configured between the PDSCH and the PUCCH. The DCI may indicate the codebook index out of a predefined or configured range (e.g., 0 to 1 or 0 to 15), which may allow selecting the Type 1 or Type 2 HARQ-ACK codebook instead of the slot of PUCCH signaled by k1 and k0. In other words, instead of implicitly determining the codebook index by the slot of PUCCH signaled by k1 and k0 in legacy procedure, the codebook index may be explicitly indicated in the DCI.

In some implementations, the UE may determine a copy of the MAC-CE including the at least one of the HARQ-ACK codebook and the CSI report. The UE may determine another MAC PDU including the copy of the MAC-CE and transmit the MAC PDU including the copy of the MAC-CE to the network node.

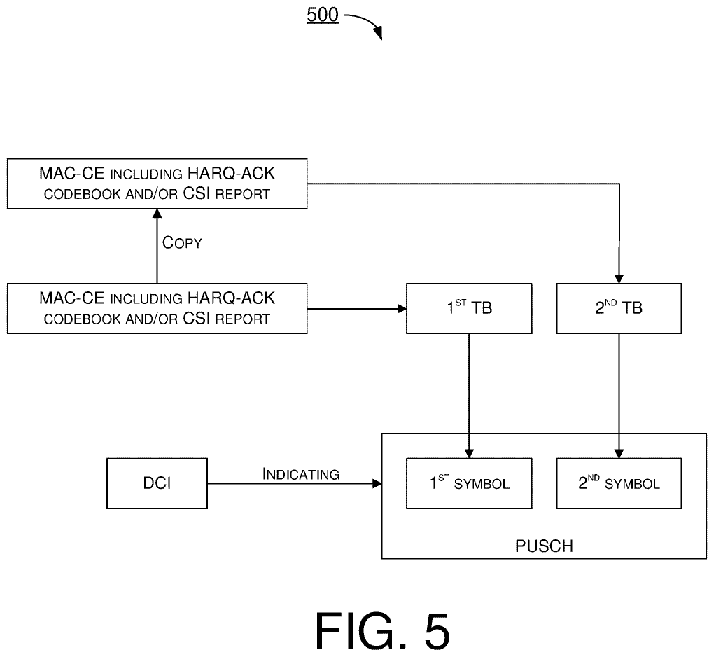

FIG. 5 illustrates an example scenario 500 under schemes in accordance with implementations of the present disclosure. For example, the DCI indicates a PUSCH transmission. The MAC-CE including the at least one of the HARQ-ACK codebook and the CSI report is multiplexed in the MAC PDU and transmitted in a first TB via a first symbol used for the PUSCH transmission. The copy of the MAC-CE is multiplexed in another MAC PDU and transmitted in a second TB via a second symbol used for the PUSCH transmission.

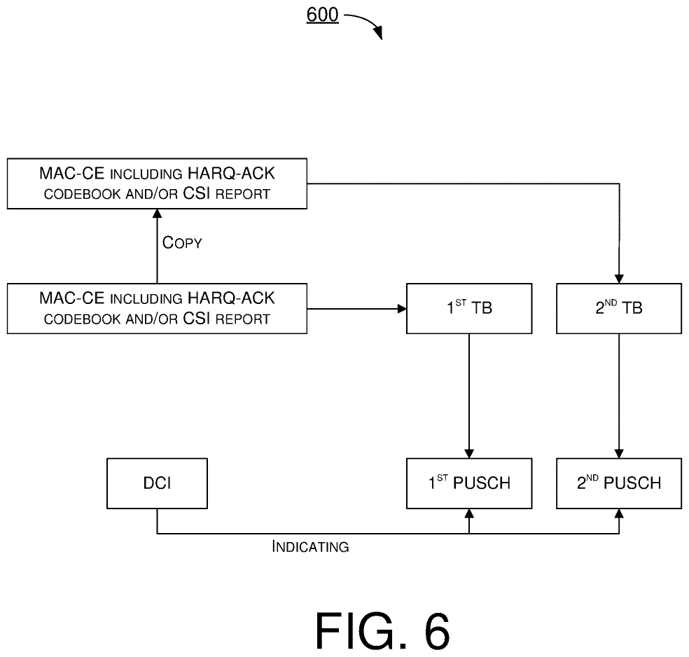

FIG. 6 illustrates an example scenario 600 under schemes in accordance with implementations of the present disclosure. For example, the DCI indicates a first PUSCH transmission and a second PUSCH transmission. The MAC-CE including the at least one of the HARQ-ACK codebook and the CSI report is multiplexed in the MAC PDU and transmitted in a first TB via the first PUSCH transmission. The copy of the MAC-CE is multiplexed in another MAC PDU and transmitted in a second TB via the second PUSCH transmission.

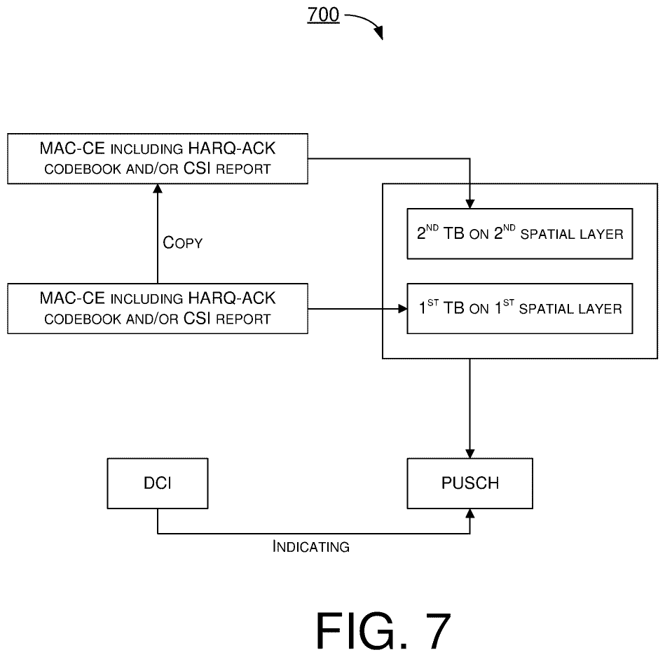

FIG. 7 illustrates an example scenario 700 under schemes in accordance with implementations of the present disclosure. For example, the DCI indicates a PUSCH transmission. The MAC-CE including the at least one of the HARQ-ACK codebook and the CSI report is multiplexed in the MAC PDU and transmitted in a first TB on a first spatial layer via the PUSCH transmission. The copy of the MAC-CE is multiplexed in another MAC PDU and transmitted in a second TB on a second spatial layer via the PUSCH transmission.

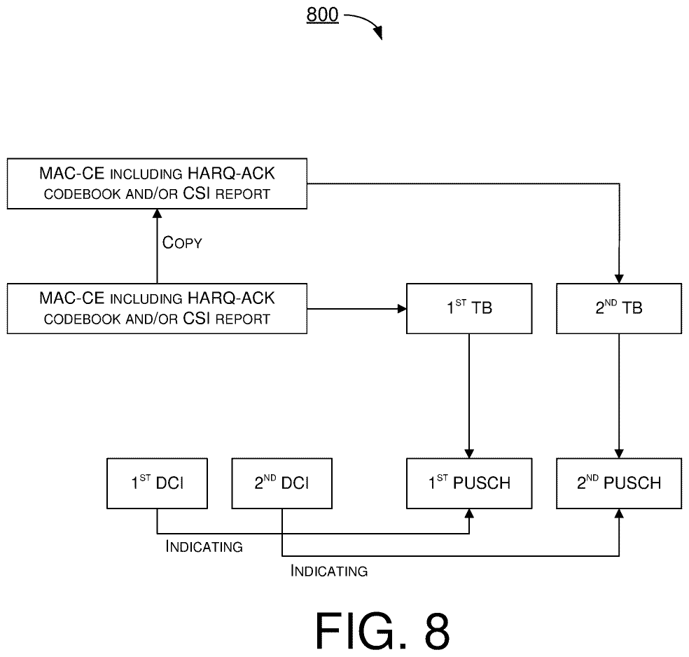

FIG. 8 illustrates an example scenario 800 under schemes in accordance with implementations of the present disclosure. For example, there are a first DCI indicating a first PUSCH transmission and a second DCI indicating a second PUSCH transmission. The MAC-CE including the at least one of the HARQ-ACK codebook and the CSI report is multiplexed in the MAC PDU and transmitted in a first TB via the first PUSCH transmission. The copy of the MAC-CE is multiplexed in another MAC PDU and transmitted in a second TB via the second PUSCH transmission.

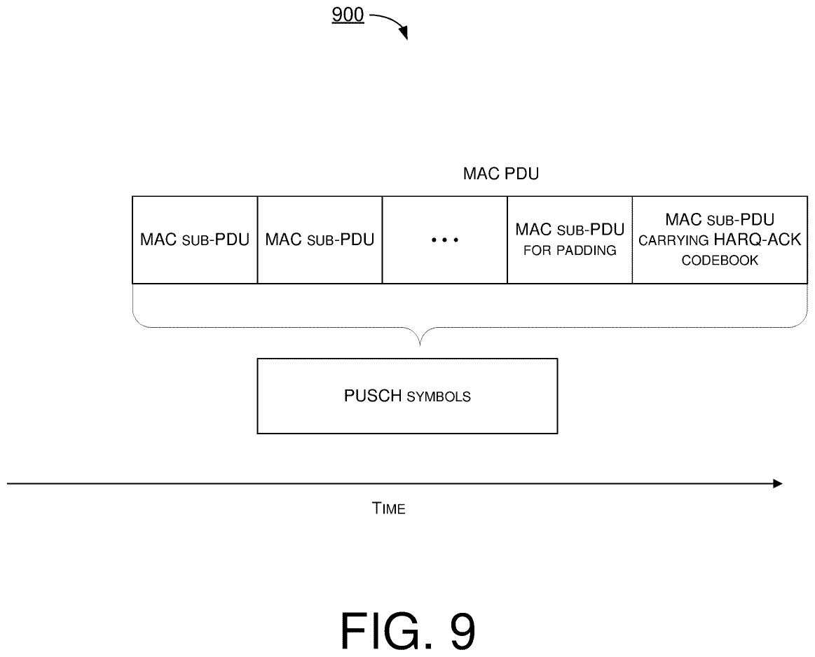

FIG. 9 illustrates an example scenario 900 under schemes in accordance with implementations of the present disclosure. In some implementations, the MAC PDU may be mapped onto a plurality of symbols of a PUSCH. A last MAC sub-PDU of the MAC PDU may include the MAC-CE including the HARQ-ACK codebook. The MAC-CE may be after an SDU in the MAC sub-PDU. In other words, when the MAC PDU is mapped onto multiple symbols (e.g., orthogonal frequency division multiplexing symbols), the MAC-CE including the HARQ-ACK codebook may be appended after the SDU. In some cases, the last MAC sub-PDU of the MAC PDU may be after the padding.

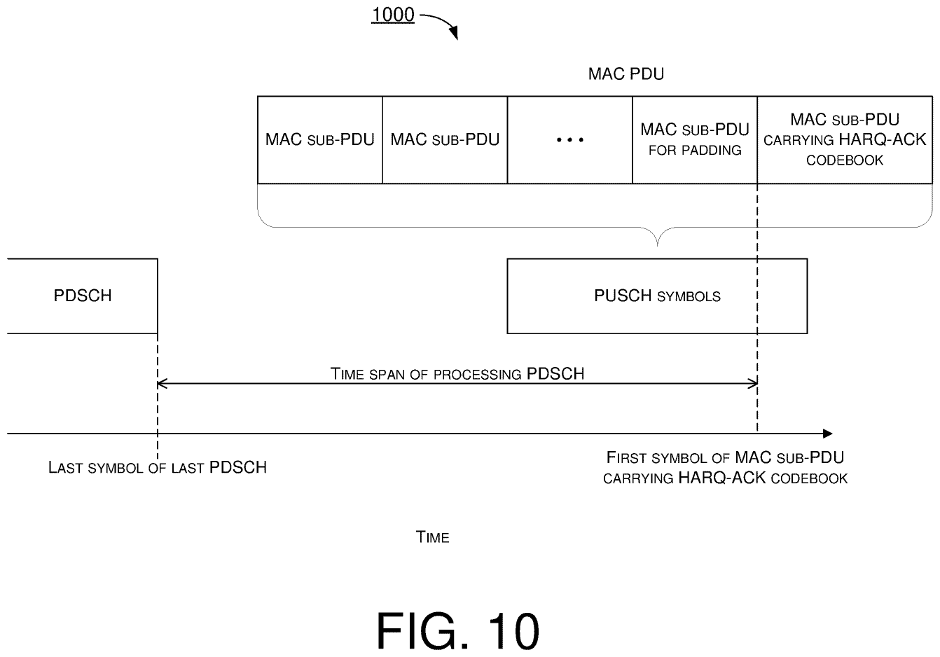

FIG. 10 illustrates an example scenario 1000 under schemes in accordance with implementations of the present disclosure. In some implementations, a time span of processing the PDSCH may end at a first symbol of the MAC sub-PDU including the MAC-CE. More specifically, the time span of processing the PDSCH may be Tproc (defined in 3^{rd} generation partnership project (3GPP) specification) while NI (defined in 3GPP specification) may be a factor determining the Tproc. An endpoint of the time span (i.e., a last symbol of the last PDSCH) may be the first UL symbol where the MAC-CE is transmitted so that the time span of processing the PDSCH may be satisfied.

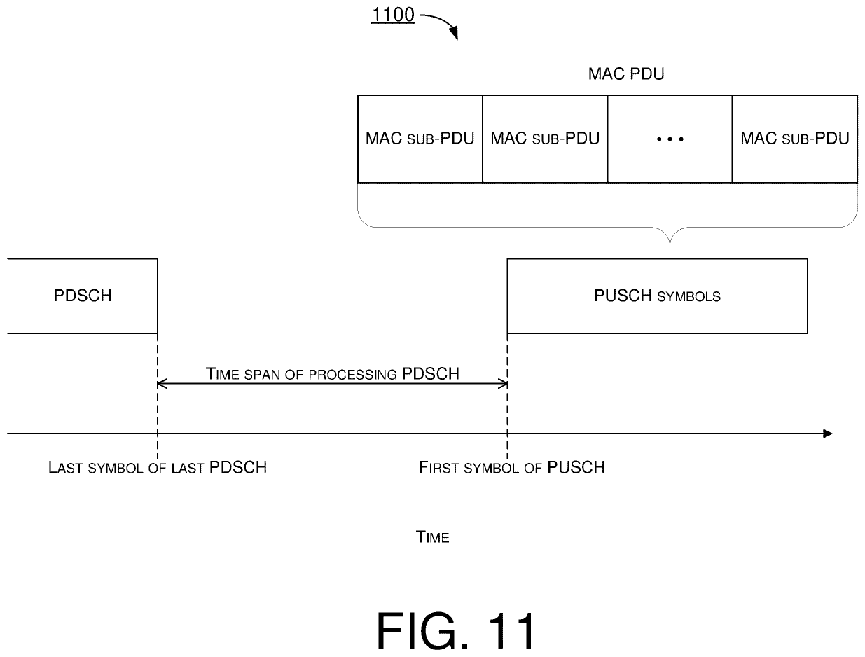

FIG. 11 illustrates an example scenario 1100 under schemes in accordance with implementations of the present disclosure. In some implementations, a time span of processing the PDSCH may end at a first symbol of the PUSCH. More specifically, the time span of processing the PDSCH may be Tproc (defined in 3GPP specification) while N1 (defined in 3GPP specification) may be a factor determining the Tproc. An endpoint of the time span may be the first UL symbol of the PUSCH.

In some implementations, PUCCH formats 2/3/4 may be used in scheduling without arbitration between: (1) PUCCH and PUCCH; or (2) PUCCH and PUSCH. In other words, because there is not any time overlap between: (1) PUCCH and PUCCH; or (2) PUCCH and PUSCH, the UE ay not need to resolve any time-domain overlap.

### Illustrative Implementations

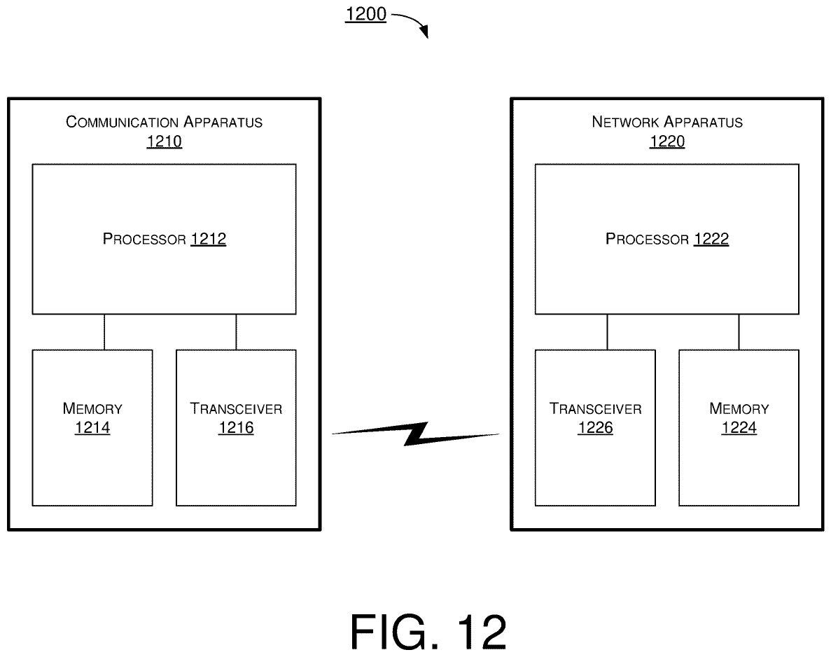

FIG. 12 illustrates an example communication system 1200 having an example communication apparatus 1210 and an example network apparatus 1220 in accordance with an implementation of the present disclosure. Each of communication apparatus 1210 and network apparatus 1220 may perform various functions to implement schemes, techniques, processes and methods described herein pertaining to UCI transmission with respect to UE and network apparatus in mobile communications, including scenarios/schemes described above as well as processes 1300 and 1400 described below.

Communication apparatus 1210 may be a part of an electronic apparatus, which may be a UE such as a portable or mobile apparatus, a wearable apparatus, a wireless communication apparatus or a computing apparatus. For instance, communication apparatus 1210 may be implemented in a smartphone, a smartwatch, a personal digital assistant, a digital camera, or a computing equipment such as a tablet computer, a laptop computer or a notebook computer. Communication apparatus 1210 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1210 may be implemented in a smart thermostat, a smart fridge, a smart door lock, a wireless speaker or a home control center. Alternatively, communication apparatus 1210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1210 may include at least some of those components shown in FIG. 12 such as a processor 1212, for example. Communication apparatus 1210 may further include one or more other components not pertinent to the proposed scheme of the present disclosure (e.g., internal power supply, display device and/or user interface device), and, thus, such component(s) of communication apparatus 1210 are neither shown in FIG. 12 nor described below in the interest of simplicity and brevity.

Network apparatus 1220 may be a part of a network apparatus, which may be a network node such as a satellite, a base station, a small cell, a router or a gateway. For instance, network apparatus 1220 may be implemented in an eNodeB in an LTE network, in a gNB in a 5G/NR, IoT, NB-IoT or IIoT network or in a satellite or base station in a 6G network. Alternatively, network apparatus 1220 may be implemented in the form of one or more IC chips such as, for example and without limitation, one or more single-core processors, one or more multi-core processors, or one or more RISC or CISC processors. Network apparatus 1220 may include at least some of those components shown in FIG. 12 such as a processor 1222, for example. Network apparatus 1220 may further include one or more other components not pertinent to the proposed scheme of the present disclosure (e.g., internal power supply, display device and/or user interface device), and, thus, such component(s) of network apparatus 1220 are neither shown in FIG. 12 nor described below in the interest of simplicity and brevity.

In one aspect, each of processor 1212 and processor 1222 may be implemented in the form of one or more single-core processors, one or more multi-core processors, or one or more CISC processors. That is, even though a singular term “a processor” is used herein to refer to processor 1212 and processor 1222, each of processor 1212 and processor 1222 may include multiple processors in some implementations and a single processor in other implementations in accordance with the present disclosure. In another aspect, each of processor 1212 and processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1212 and processor 1222 is a special-purpose machine specifically designed, arranged and configured to perform specific tasks including UCI transmission in a device (e.g., as represented by communication apparatus 1210) and a network (e.g., as represented by network apparatus 1220) in accordance with various implementations of the present disclosure.

In some implementations, communication apparatus 1210 may also include a transceiver 1216 coupled to processor 1212 and capable of wirelessly transmitting and receiving data. In other words, processor 1212 may transceive the data such as configuration, message, signal, information, indicator, etc. via transceiver 1216. In some implementations, communication apparatus 1210 may further include a memory 1214 coupled to processor 1212 and capable of being accessed by processor 1212 and storing data therein. In some implementations, network apparatus 1220 may also include a transceiver 1226 coupled to processor 1222 and capable of wirelessly transmitting and receiving data. In other words, processor 1222 may transceive the data such as configuration, message, signal, information, indicator, etc. via transceiver 1226. In some implementations, network apparatus 1220 may further include a memory 1224 coupled to processor 1222 and capable of being accessed by processor 1222 and storing data therein. Accordingly, communication apparatus 1210 and network apparatus 1220 may wirelessly communicate with each other via transceiver 1216 and transceiver 1226, respectively. To aid better understanding, the following description of the operations, functionalities and capabilities of each of communication apparatus 1210 and network apparatus 1220 is provided in the context of a mobile communication environment in which communication apparatus 1210 is implemented in or as a communication apparatus or a UE and network apparatus 1220 is implemented in or as a network node of a communication network.

In some implementations, each of memory 1214 and memory 1224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1214 and memory 1224 may include a type of read-only memory (ROM) such as mask ROM, programmable ROM (PROM), erasable programmable ROM (EPROM) and/or electrically erasable programmable ROM (EEPROM). Alternatively, or additionally, each of memory 1214 and memory 1224 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

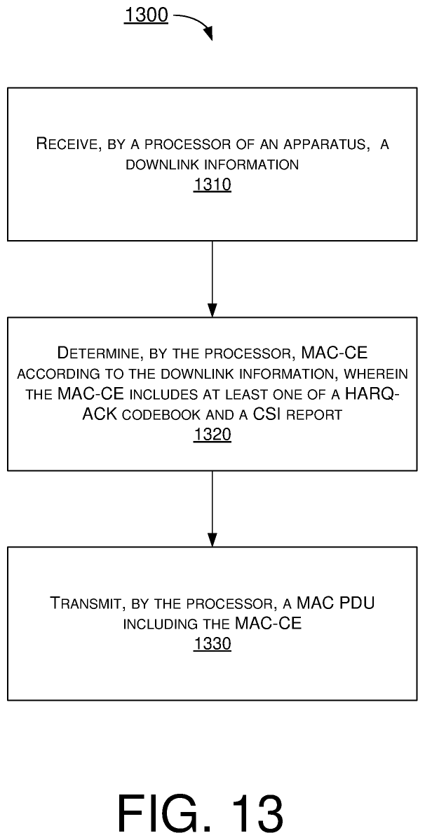

FIG. 13 illustrates an example process 1300 in accordance with an implementation of the present disclosure. Process 1300 may be an example implementation of above scenarios/schemes, whether partially or completely, with respect to UCI transmission of the present disclosure. Process 1300 may represent an aspect of implementation of features of communication apparatus 1210. Process 1300 may include one or more operations, actions, or functions as illustrated by one or more of blocks 1310 to 1330. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by communication apparatus 1210 or any suitable UE or machine type devices. Solely for illustrative purposes and without limitation, process 1300 is described below in the context of communication apparatus 1210. Process 1300 may begin at block 1310.

At block 1310, process 1300 may involve processor 1212 of communication apparatus 1210 receiving a downlink information. Process 1300 may proceed from block 1310 to block 1320.

At block 1320, process 1300 may involve processor 1212 of communication apparatus 1210 determining a media access control-control element (MAC-CE) according to the downlink information. The MAC-CE may include at least one of a HARQ-ACK codebook and a CSI. Process 1300 may proceed from block 1320 to block 1330.

At block 1330, process 1300 may involve processor 1212 of communication apparatus 1210 transmitting a MAC PDU including the MAC-CE.

In some implementations, a MAC-CE header of the MAC PDU may be without length field.

In some implementations, an index of the HARQ-ACK may be included in a MAC-CE header or a payload of the MAC PDU.

In some implementations, the downlink information may include a DCI, and the DCI may include a codebook index indicating an index of the HARQ-ACK codebook.

In some implementations, process 1300 involve processor 1212 of communication apparatus 1210 determining a copy of the MAC-CE. Process 1300 may involve processor 1212 of communication apparatus 1210 transmitting another MAC PDU including the copy of the MAC-CE.

In some implementations, the MAC PDU may be mapped onto a plurality of symbols of a PUSCH. A last MAC sub-PDU of the MAC PDU may include the MAC-CE. The MAC-CE may be after an SDU in the MAC sub-PDU.

In some implementations, a time span of processing the PDSCH may end at a first symbol of the MAC sub-PDU including the MAC-CE.

In some implementations, the MAC PDU may be mapped onto a plurality of symbols of a PUSCH. A time span of processing the PDSCH may end at a first symbol of the PUSCH.

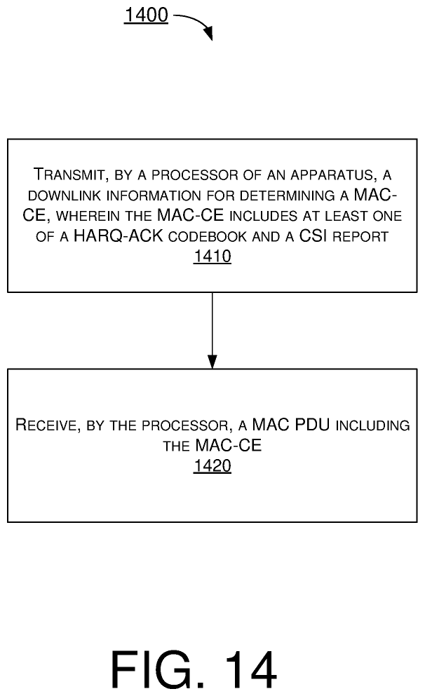

FIG. 14 illustrates an example process 1400 in accordance with an implementation of the present disclosure. Process 1400 may be an example implementation of above scenarios/schemes, whether partially or completely, with respect to UCI transmission of the present disclosure. Process 1400 may represent an aspect of implementation of features of network apparatus 1220. Process 1400 may include one or more operations, actions, or functions as illustrated by one or more of blocks 1410 to 1420. Although illustrated as discrete blocks, various blocks of process 1400 may be divided into additional blocks, combined into fewer blocks, or eliminated, depending on the desired implementation. Moreover, the blocks of process 1400 may be executed in the order shown in FIG. 14 or, alternatively, in a different order. Process 1400 may be implemented by network apparatus 1220 or any suitable network device or machine type devices. Solely for illustrative purposes and without limitation, process 1400 is described below in the context of network apparatus 1220. Process 1400 may begin at block 1410.

At block 1410, process 1400 may involve processor 1222 of network apparatus 1220 transmitting a downlink information for determining a MAC-CE according to the downlink information. The MAC-CE may include at least one of a HARQ-ACK codebook and a CSI report. Process 1400 may proceed from block 1410 to block 1420.

At block 1420, process 1400 may involve processor 1222 of network apparatus 1220 receiving a MAC PDU including the MAC-CE.

In some implementations, a MAC-CE header of the MAC PDU may be without length field.

In some implementations, an index of the HARQ-ACK may be included in a MAC-In

In some implementations, downlink information may include a DCI, and the DCI includes a codebook index indicating an index of the HARQ-ACK codebook.

In some implementations, process 1400 may involve processor 1222 of network apparatus 1220 receiving another MAC PDU including a copy of the MAC-CE.

In some implementations, the MAC PDU may be mapped onto a plurality of symbols of a PUSCH. A last MAC sub-PDU of the MAC PDU may include the MAC-CE. The MAC-CE may be after an SDU in the MAC sub-PDU.

In some implementations, a time span of processing the PDSCH may end at a first symbol of the MAC sub-PDU including the MAC-CE.

In some implementations, the MAC PDU may be mapped onto a plurality of symbols of a PUSCH. A time span of processing the PDSCH may end at a first symbol of the PUSCH.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink information;
determining, by the processor, a media access control-control element (MAC-CE) according to the downlink information, wherein the MAC-CE includes at least one of a hybrid automatic repeat request-acknowledgment (HARQ-ACK) codebook and a channel state information (CSI) report; and
transmitting, by the processor, a MAC packet data unit (MAC PDU) including the MAC-CE.

2. The method of claim 1, wherein a MAC-CE header of the MAC PDU is without length field.

3. The method of claim 1, wherein an index of the HARQ-ACK is included in a MAC-CE header or a payload of the MAC PDU.

4. The method of claim 1, wherein downlink information includes a downlink control information (DCI), and the DCI includes a codebook index indicating an index of the HARQ-ACK codebook.

5. The method of claim 1, further comprising:
determining, by the processor, a copy of the MAC-CE; and
transmitting, by the processor, another MAC PDU including the copy of the MAC-CE.

6. The method of claim 1, wherein the MAC PDU is mapped onto a plurality of symbols of a physical uplink shared channel (PUSCH), a last MAC sub-PDU of the MAC PDU includes the MAC-CE, and the MAC-CE is after a service data unit (SDU) in the MAC sub-PDU.

7. The method of claim 6, wherein a time span of processing the PDSCH ends at a first symbol of the MAC sub-PDU including the MAC-CE.

8. The method of claim 1, wherein the MAC PDU is mapped onto a plurality of symbols of a physical uplink shared channel (PUSCH), and a time span of processing the PDSCH ends at a first symbol of the PUSCH.

9. A method, comprising:
transmitting, by a processor of an apparatus, a downlink information for determining a media access control-control element (MAC-CE) according to the downlink information, wherein the MAC-CE includes at least one of a hybrid automatic repeat request-acknowledgment (HARQ-ACK) codebook and a channel state information (CSI) report; and
receiving, by the processor, a MAC packet data unit (MAC PDU) including the MAC-CE.

10. The method of claim 9, wherein a MAC-CE header of the MAC PDU is without length field.

11. The method of claim 9, wherein an index of the HARQ-ACK is included in a MAC-CE header or a payload of the MAC PDU.

12. The method of claim 9, wherein downlink information includes a downlink control information (DCI), and the DCI includes a codebook index indicating an index of the HARQ-ACK codebook.

13. The method of claim 9, further comprising:
receiving, by the processor, another MAC PDU including a copy of the MAC-CE.

14. The method of claim 9, wherein the MAC PDU is mapped onto a plurality of symbols of a physical uplink shared channel (PUSCH), a last MAC sub-PDU of the MAC PDU includes the MAC-CE, and the MAC-CE is after a service data unit (SDU) in the MAC sub-PDU.

15. The method of claim 14, wherein a time span of processing the PDSCH ends at a first symbol of the MAC sub-PDU including the MAC-CE.

16. The method of claim 9, the MAC PDU is mapped onto a plurality of symbols of a physical uplink shared channel (PUSCH), and a time span of processing the PDSCH ends at a first symbol of the PUSCH.

17. An apparatus, comprising:
a transceiver which, during operation, wirelessly communicates with a wireless network; and
a processor communicatively coupled to the transceiver such that, during operation, the processor performs operations comprising:
receiving, by the transceiver, a downlink information;
determining a media access control-control element (MAC-CE) according to the downlink information, wherein the MAC-CE includes at least one of a hybrid automatic repeat request-acknowledgment (HARQ-ACK) codebook and a channel state information (CSI) report; and
transmitting, via the transceiver, a MAC packet data unit (MAC PDU) including the MAC-CE.

18. The apparatus of claim 17, wherein an index of the HARQ-ACK is included in a MAC-CE header or a payload of the MAC PDU.

19. The apparatus of claim 17, downlink information includes a downlink control information (DCI), and the DCI includes a codebook index indicating an index of the HARQ-ACK codebook.

20. The apparatus of claim 17, wherein, during operation, the processor further performs operations comprising:
determining a copy of the MAC-CE and
transmitting, via the transceiver, another MAC PDU including the copy of the MAC-CE.
